(19) United States
(12) Patent Application Publication
(10) Pub. No.: US 2006/0110472 A1
(43) Pub. Date: May 25, 2006

(54) Use of allicin as insect repellent and insecticide in agricultural crops

(76) Inventors: Talia Miron, Kfar Haim (IL); Aharon Rabinkov, Rehovot (IL); Meir Wilchek, Rehovot (IL); David Mirelman, Ramat Efal (IL); Talila Volk, Rehovot (IL)

Correspondence Address: BROWDY AND NEIMARK, P.L.L.C.;624 NINTH STREET, NW, SUITE 300, WASHINGTON, DC, 20001-5303, US

(21) Appl. No.: 10/512,553

(22) PCT Filed: Apr. 24, 2003
(86) PCT No.: PCT/IL03/00330

§ 371 Date: Jan. 19, 2006

Related U.S. Application Data
(60) Provisional application No. 60/375,053, filed on Apr. 25, 2002.

(51) Int. Cl. A01N 65/00; A01N 31/00

(52) U.S. Cl. 424/754; 514/706

(57) ABSTRACT

The invention provides methods for: (a) protecting agricultural crops, particularly fruits and vegetables, against insects, by treating the crops with allicin prior to harvesting; (b) protecting fruits and vegetables from decay and extending the shelf life thereof by treating the fruits and vegetables with allicin after harvesting; and (c) repelling insects such as ants or insects that attack agricultural crops from an object or an area, which comprises treating the object or area with a repelling effective amount of allicin.

### FIELD OF THE INVENTION

The present invention is directed to methods related to the use of allicin as an insecticide and insect repellent suitable for use on agricultural crops, as an ant repellent and for the treatment of fresh fruits and vegetables post-harvesting.

### BACKGROUND OF THE INVENTION

The existence and, to some extent, the quality of agricultural crops, depend on the ability of the farmer to control damage caused by insects to the crops. The indiscriminate use of chemical pesticides widely used for many years kills harmful as well as beneficial insects and causes damage to the environment. One alternative to the use of chemical pesticides consists in the use of repellents.

Insect repellents have been used over the years to prevent insects from attacking humans, animals and plants. Examples of insect repellents are oils, both mineral and vegetable oils, and synthetic chemicals such as dichlorodiphenyl-trichloroethane (DDT) and N,N,-diethyl toluamide (DEET). These synthetic chemicals, although effective, were found to be toxic to humans and animals when swallowed or absorbed through the skin. DDT was originally widely used as insecticide for protecting crops from insect damage and in combating diseases spread by insects, but is now banned in the United States and in other countries because of the ecological damages it causes. Residues from DDT and other non-biodegradable insecticides have been shown to remain in the ecosystem and the food chain long after their original use. Another factor of concern in the use of synthetic chemicals is their possible reduced effect on future generations of insects. Through mutation and natural selection, insects have built resistance towards these chemicals.

Increasing environmental awareness and consumers' demand for more natural products has promoted the search for natural products for insect control and their use in the treatment of agricultural crops, particularly edible crops, namely vegetables and fruits that are marketed directly from the field to the market, and in the prosperous branch of organic crops that requires cultivation of fruits and vegetables with non-toxic, natural-based substances rather than synthetic chemicals.

Numerous natural substances by themselves or combinations thereof are known to act as insect repellents. For example, U.S. Pat. No. 5,885,600 describes an insect repellent composition comprising a mixture of the essential Neem, Citronella and Cedarwood oils for application to humans, animals, and vegetation.

Among the natural products, garlic and preparations thereof (garlic juice, garlic extracts, garlic oil) have received much attention since ancient times as having inumerous therapeutic applications. A review of these and other applications can be found in H. P. Koch and L. D. Lawson (eds.), Garlic: the Science and Therapeutic Applications of Allium sativum L. and Related Species, Williams & Wilkins, 2^{nd} ed., 1996, Baltimore, USA.

Garlic and garlic preparations alone or in combination with other natural products are disclosed as presenting insecticidal and insect repellent activities (Koch and Lawson, supra, pp. 174-175). U.S. Pat. No. 4,876,090 discloses a systemic insect repellent composition containing aneurine and allium sativum for protection of domesticated animals against fleas, ticks and other blood feeding pests. U.S. Pat. No. 5,429,817 describes an insect repellent comprising garlic and water adapted to be sprayed on fruits, vegetables and plants of all types. U.S. Pat. No. 5,711,953 provides insect repellent compositions comprising garlic juice and a hot pepper component for application to domesticated animals. Garlic extract has been proposed in U.S. Pat. No. 5,733,552 for repelling mosquitoes from a grassy recreational area, e.g. a golf course. A pest repellent mixture comprising equal amounts of red pepper, powdered garlic and black pepper, and hydrated calcium hydroxide as stabilizer is disclosed in U.S. Pat. No. 5,756,100. International Patent Application No. PCT/US02/01204 (WO 02/056683) discloses a method for sterilization of soil against plant pathogenic organisms selected from fungi, bacteria and protozoa, which comprises administering allicin to the soil prior to seeding and planting.

### SUMMARY OF THE INVENTION

The present invention relates to the use of allicin as insecticide and insect repellent for agricultural crops.

The invention also relates to a method for protecting agricultural crops against insects which comprises treating the crops to be protected with an effective amount of allicin prior to harvesting.

The invention further relates to a method for protecting fruits and vegetables from decay which comprises treating the fruits and vegetables with allicin after harvesting, particularly when said decay is caused by attack by insects.

The invention still further relates to a method for extending shelf life of fresh fruits and vegetables which comprises treating the fruits and vegetables with allicin after harvesting.

The invention relates yet further relates to a method for repelling insects from an object or an area which comprises treating the object or area with a repelling effective amount of allicin.

### BRIEF DESCRIPTION OF THE FIGURES

FIGS. 1a-1b show the effect of allicin on the number of eggs laid by fruit flies allowed to lay eggs for 16 hours on plates containing various allicin concentrations (0-12 mM allicin) (FIG. 1a) and for 8 hours on allicin-free plates after the exposure to the various concentrations of allicin (FIG. 1b). The results are shown as % in comparison to eggs laid in the absence of allicin (considered as 100%).

FIG. 2 is a photograph of persimmon fruits from trees treated with allicin (left) and from untreated trees (right).

### DETAILED DESCRIPTION OF THE INVENTION

Allicin (thio-2-propene-1-sulfinic acid S-allyl ester), one of the biologically active molecules that is rapidly generated upon crushing of garlic cloves, is a chemically poorly stable, colorless liquid that is apparently responsible for both the odor and much, but not all, of the biological activity and the beneficial properties ascribed to garlic and its preparations.

Allicin does not exist in intact garlic cloves, but is obtained from its odorless precursor alliin (+-S-allyl-L-cysteine sulfoxide) in the presence of the enzyme alliinase. In the garlic clove, alliin and alliinase are found in different compartments. When the garlic clove is cut or crushed, both the enzyme and alliin come in contact thus initiating allicin production. This is the reason why whole garlic cloves exhibit little or no odor until they are sliced or crushed.

Allicin is a very labile and volatile compound when exposed to air and many of the methods known today for its preparation are not satisfactory. The chemical synthesis involves many steps and is complicated, laborious, expensive, and very inefficient. The enzymatic method seems to be more attractive, however alliinase is a so-called “suicidal enzyme” that is rapidly and irreversibly inactivated by its own reaction product, allicin. Therefore, a few minutes incubation of alliinase with the substrate alliin or its product, allicin, leads to a biologically inactive enzyme after one or a very limited number of cycles. This problem has been solved recently by the present inventors through the procedure described in International PCT Publication No. WO 97/39115, whereby the enzyme alliinase is chemically, physically or biologically immobilized and large amounts of substantially pure allicin in aqueous solution can be continuously produced by a method which comprises adding the substrate alliin to a column containing the immobilized alliinase.

As mentioned above, allicin has been shown to exhibit many, but not all, beneficial activities presented by garlic. Allicin has been shown to present antibiotic e.g. antibacterial, antifungal, antiprotozoal, antiviral and antiparasitic activities, as well as anticancer, anti-inflammatory, antioxidant, antithrombotic, hypoglycemic and immunomodulatory effects (Koch and Lawson, supra, Chapter 5, pp. 135-212).

As described in the Background section of the present application, garlic and garlic preparations alone or in combination with other natural products are disclosed as presenting insecticidal and insect repellent activities but none of the publications discloses or suggests that allicin itself has these properties.

The present invention provides, in one aspect, a method for protecting agricultural crops against insects which comprises treating the crops to be protected with an effective amount of allicin prior to harvesting.

Because allicin is a natural non-toxic compound that is used as food additive and is friendly to the environment, its use is particularly suitable for organically grown agricultural crops.

The agricultural crops to be protected according to the invention are preferably fruits or vegetables such as, but not limited to, apples, avocados, pears, apricots, persimmon, figs, citrus fruits, plums, lime, cherries, guavas, peaches, tangerine, kumquats, loquats, nectarines, mangos, peppers and tomatoes. In one preferred embodiment, the fruit is persimmon.

According to the invention, allicin can be used to protect agricultural crops from insects that attack plants, fruits and/or vegetables. In one particular embodiment, the insect is fruit fly. There are many species of fruit flies found in most tropical and subtropical areas of the world. The Mediterranean fruit fly, commonly called medfly, is one of the world's most destructive agricultural pests and attacks more than 260 different fruits, flowers, vegetables and nuts including peaches, pears, plums, apples, apricots, avocados, citrus, cherries, figs, grapes, guavas, kumquats, loquats, nectarines, peppers, persimmons, tomatoes, and several nuts. The fruit fly is a major pest in persimmon orchards of the Mediterranean region. The female medfly attacks ripening fruit, piercing the soft skin and laying eggs in the puncture. The eggs hatch into wormlike larvae (maggots), which feed inside the fruit pulp or vegetables before dropping to the ground. In the soil, the larvae transform into pupae, and the pupae mature and emerge from the soil as adult flies.

Allicin can be applied to the plant, fruit or vegetable before harvesting in any suitable manner, e.g. by spraying, dusting, or by aerosol, either aerially or from the ground. Allicin may be optionally used with a carrier such as water.

In another aspect, the present invention provides a method for protecting fruits and vegetables from decay which comprises treating the fruits and vegetables with allicin after harvesting, in particular when the decay is caused by attack by insects.

In a further aspect, the present invention provides a method for extending shelf life of fresh fruits and vegetables which comprises treating the fruits and vegetables with allicin after harvesting.

In still another aspect, the present invention relates to the use of allicin as insect repellent. In this aspect, allicin can be used for repelling ants as well as for repelling insects that attack agricultural crops.

Thus, the invention provides a method for repelling ants from an object or an area, which comprises treating the object or area with a repelling effective amount of allicin, optionally together with a carrier, preferably water. The object may be, for example, a container containing food, and the area may be in the interior of a house or situated outdoors. If the area is situated outdoors and, depending on the weather conditions, higher amounts of allicin may be needed than if used indoors. Certain types of ants are known to attack trees, particularly citrus and other agriculturally important trees, and thus spraying allicin around the trees will prevent the trees being attacked by the ants.

In yet a further aspect, the present invention relates to the use of allicin as insecticide.

The results obtained according to the invention clearly demonstrate that treatment of persimmon fruits with a solution of allicin can be a very effective method for protection of persimmon fruits against fruit fly. Other fruits and vegetables can be protected from insect attack by the procedure of the invention using allicin in aqueous solution, which is simple and straightforward. In addition, allicin is a natural plant product that is now easy and cheap to produce, is not toxic to plants or animals and is environmentally safe, and thus represents an attractive alternative to synthetic chemicals in agriculture, particularly in organic and edible crops.

The invention will be now illustrated by the following non-limiting examples.

### EXAMPLES

Materials

Allin was synthesized according to the procedure of Stoll and Seebeck (Chemical investigation on alliin, the specific principle of garlic. Adv. Enzymol., (1951) Vol. 11, pp. 377-400).

Allicin (2 mg/ml) in water solution (in Na-phosphate buffer 50 mM, pH 6.5) was prepared by applying synthetic alliin onto an immobilized alliinase column according to the procedure described in WO 97/39115, or it was chemically synthesized by oxidation of diallyldisulfide by known methods.

### Example 1

### Insecticide and Repellent Activities of Allicin

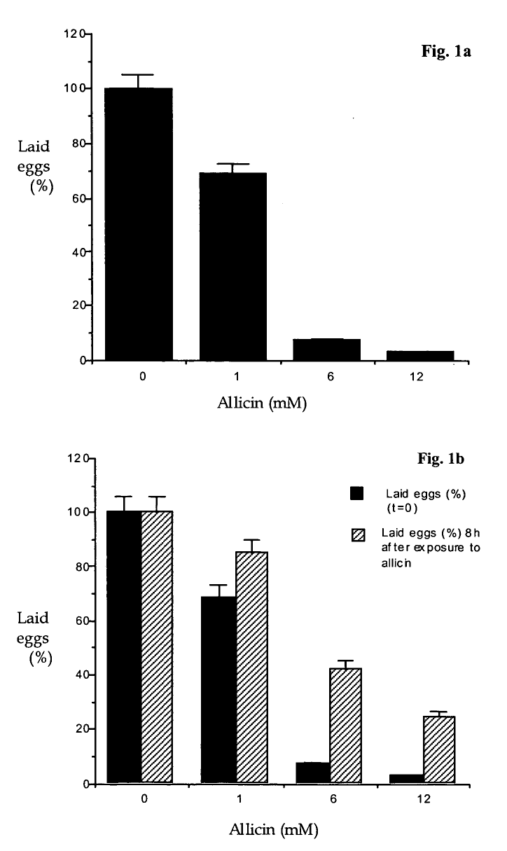

Fruit flies, Drosophila Melanogaster, were grown in a plastic container and allowed to lay eggs in laying bottles (6×4 cm) containing allicin (100 μl) in various concentrations (0-12 mM). Allicin was introduced to the egg-laying sites on a ring of Whatman (3 mm) paper placed at the periphery of the egg laying plate which was placed at the bottom of the bottle. A yeast paste (fly food) was applied in the middle of the plate. Female fruit flies (N=100) were introduced into the laying bottle and were allowed to lay eggs for 16 hours. At the end of the 16 hours, the number of eggs was counted in each plate. The total number of eggs laid by the flies was 1440. The repellent effect of allicin on the fruit fly was determined by measuring the number of laid eggs during the continuous exposure of the flies to the various concentrations of allicin. The results are shown in FIG. 1a as a percentage of laid eggs in the presence of each concentration of allicin in comparison with the number of eggs laid by flies in the absence of allicin (first column, left—100%). It can be seen that the repellent activity of allicin, represented by the inhibition of egg laying by the flies, is dose-dependent and the number of laid eggs decrease with the increase of allicin concentration.

The flies were then transferred to allicin-free plates and allowed to lay eggs for 8 hours. At the end of the 8 hours, the number of eggs was counted in each plate. The total number of eggs laid by the flies was 1708. The repellent effect of allicin on the fruit fly was determined by measuring the number of laid eggs in allicin-free plates for 8 hours after the 16-hour exposure of the flies to the various concentrations of allicin. The results are shown in FIG. 1b in the gray columns as a percentage of laid eggs by flies that were exposed in the first stage to each concentration of allicin in comparison with the number of eggs laid by flies that were not exposed to allicin at the first stage (first column, left—100%). The black columns in FIG. 1b correspond to the black columns in FIG. 1a. FIG. 1b shows that a significant inhibition effect on the capability of the flies to lay eggs was still observed when flies were allowed to lay on allicin-free plates for 8 hours after exposure to allicin during 16 hours, and this effect was still dose-dependent.

In an additional experiment, lethality of 80-90% of the hatched larvae produced in the second phase of the fly life cycle was caused by addition of allicin (stock 1-2 mg/ml) to egg-laying plates containing about 200 eggs per plate (not shown).

### Example 2

### Repellent Effect of Allicin on Persimmon Fruit

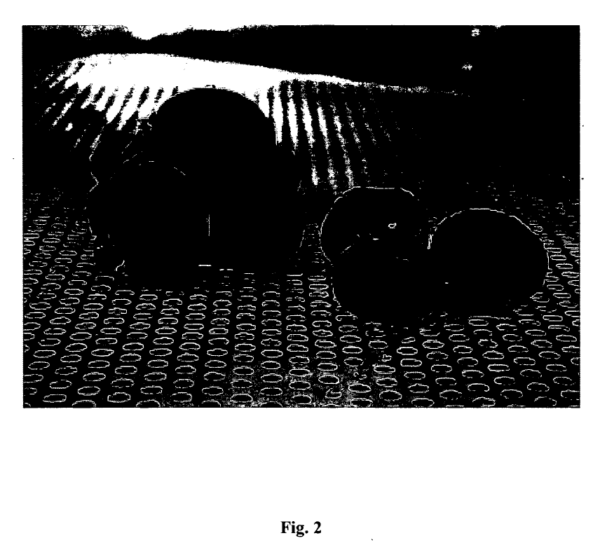

Persimmon trees (Oriental persimmon of the type “Fuyu”, 2.5-3 meters tall) in the Hasharon region, Israel, were sprayed with a water solution of allicin (0.1-0.2 g/l, 0.01-0.02% or 0.5-1 mM) every second week, during a 12-week period, for a total of 6 sessions. Spraying with allicin was started 2-3 weeks after persimmon fruit setting, when the fruits reached 1-2 cm in diameter. The spraying was performed in such a way as to wet the leaves and the fruits completely. No other insecticides or other treatments were used in parallel or at any point of the experiment. FIG. 2 is a photograph showing persimmon fruits from trees treated with allicin (left) and from untreated trees (right). The appearance of the fruits on the left side clearly indicates that allicin had a repellent effect on fruit flies that attack the persimmon trees in this geographical area. The leaves showed no damage after spraying with allicin.

In another experiment, persimmon fruits were sprayed post-harvesting with a water solution containing 0.01% (w/v) allicin. The treatment was repeated after one week. The fruits treated once or twice with allicin had a longer shelf life than non-treated fruits (not shown).

### Example 3

### Repellent Effect of Allicin on Ants

Treatment of the locus of an ant colony with a water solution of allicin (1 mg/ml) prevented the ants from reentering the place for at least 3 days. Adding a water solution of allicin (1 mg/ml) on a line in the floor, prevented the crossing of the line by ants, even after the allicin solution dried off.

1-17. (canceled)

18. A method for protecting agricultural crops against insects which comprises treating the crops to be protected with an effective amount of allicin prior to harvesting.

19. A method according to claim 18, wherein said agricultural crops are organically grown crops.

20. A method according to claim 18, wherein said agricultural crops are fruits or vegetables.

21. A method according to claim 20, wherein said fruits or vegetables are selected from apples, avocados, apricots, pears, persimmon, figs, citrus fruits, plums, lime, cherries, guavas, peaches, tangerine, kumquats, loquats, nectarines, mangos, peppers and tomatoes.

22. A method according to claim 21, wherein said fruit is persimmon.

23. A method according to claim 18, wherein said insect is fruit fly.

24. A method according to claim 18, wherein allicin is applied aerially or from the ground.

25. A method according to claim 24, wherein allicin is applied by spraying, dusting, or by aerosol.

26. A method for protecting fruits and vegetables from decay which comprises treating the fruits and vegetables with allicin after harvesting.

27. A method according to claim 26, wherein said decay is caused by attack by insects.

28. A method according to claim 27, wherein said insects are fruit flies.

29. A method for extending shelf life of fresh fruits and vegetables which comprises treating the fruits and vegetables with allicin after harvesting.

30. A method according to claim 29, wherein said fruits, and/or vegetables are selected from apples, avocados, apricots, pears, persimmon, figs, citrus fruits, plums, lime, cherries, guavas, peaches, tangerine, kumquats, loquats, nectarines, mangos, peppers and tomatoes.

31. A method for repelling insects from an object or an area, which comprises treating the object or area with a repelling effective amount of allicin.

32. A method according to claim 31 wherein said insects are ants.

33. A method according to claim 31 for repelling insects that attack agricultural crops.

34. The method according to claim 33 wherein said insect is fruit fly.
